(19) United States
(12) Patent Application Publication
(10) Pub. No.: US 2009/0256335 A1
(43) Pub. Date: Oct. 15, 2009

(54) MOTOR VEHICLE INTERIOR TRIM PART WITH AN AIRBAG DEVICE

(76) Inventors: Markus Reil, Eisenstadt (AT); Willi Schalude, Ettenheim (DE); Georg Kirchbaumer, Bad Hersfeld (DE); Jean Christophe Girard, Montbeliard (FR)

Correspondence Address: MAGNA INTERNATIONAL, INC., 337 MAGNA DRIVE, AURORA, ON, L4G-7K1, CA

(21) Appl. No.: 12/101,536

(22) Filed: Apr. 11, 2008

(51) Int. Cl. B60R 21/20

(52) U.S. Cl. 280/728.2

(57) ABSTRACT

An interior trim part with an airbag device has an airbag module (1) with a pot-shaped housing (11) for accommodating an airbag (12) which is attached at the protruding end of a firing passage (24) to a dimensionally stable support (2). An opening section (23) for the deployment of the airbag is predetermined in the support (2) by means of tear lines (21) and/or hinge lines. The problem arises of preventing, by means of a simple measure, the opening section (23) from tearing off during the deployment of the airbag (12). For this purpose, it is proposed that a first section (41) of a retaining band (4) is attached to the opening section (23), said retaining band running within the firing passage (24) as far as the base of the airbag module (1) and being fastened there. It is additionally proposed, in the sense of an even more substantial improvement, that the attachment of the retaining band (4) to the opening section (23) is placed in the vicinity of the hinge line and aligned therewith, and the retaining band (4) is guided approximately tautly through the firing passage (24).

### FIELD OF THE INVENTION

The present invention relates to an interior trim part with an airbag device for installing in a motor vehicle and, in particular, to part of an instrument panel with an airbag module.

### BACKGROUND OF THE INVENTION

The publication DE 43 11 241 C1 discloses an interior trim part with an airbag device for installing in a motor vehicle. In the embodiment illustrated therein, it is provided to secure the opening section or cover, which covers the airbag module, against the supporting structure by means of an intercepting band. However, in this case, the intercepting band is guided along the outside of the airbag module. The airbag module therefore cannot readily be fastened directly to the supporting structure of the interior trim part. In addition, because of the selected arrangement of the intercepting band, when the opening section is pushed open, the separation thereof from the remaining, fixed sections of the interior trim part arises. The separated opening section is therefore still connected only via the relatively soft intercepting band, which may result in unforeseeable dynamics of the loose part.

The official publication DE 297 11 679 U1 shows a different typical interior trim part with an airbag device for installing in a motor vehicle. It is likewise provided there to secure the cover or opening section in the support by means of an intercepting band. This embodiment also envisages the opening section being separated from the support.

Furthermore, the official publication DE 297 08 446 U1 discloses various possibilities for fastening an intercepting band to the opening section, which is to be secured, of the support of an airbag covering. In particular, possibilities are described there to connect the intercepting band to the opening section of the support in a sufficiently durable manner by means of encapsulation by injection moulding or encapsulation by foaming.

The official publication DE 44 37 773 C1 discloses an alternative to a loose intercepting band. It is proposed there to secure the opening section against tearing off by means of a reinforcing layer fastened externally. However, because of the reinforcing layer, a firing passage or a structural element delimiting the deployment space of the airbag in some other way cannot be adhesively bonded or welded to the lower side of the support. In addition, the secure attachment of the reinforcing layer requires an expanded border region next to the opening section.

With regard to the known structural forms and embodiments indicated above, the present invention addresses the problem of proposing a design for an interior trim part with an airbag device, with which the fastening of an intercepting band can take place in a particularly simple manner during the assembly of the airbag module.

### SUMMARY OF THE INVENTION

The present invention solves this problem by means of an interior trim part with the combination of features indicated in the main claim below.

The configuration according to the invention of the interior trim part very substantially facilitates the assembly thereof. The airbag module together with the gas generator is typically mounted in a manner separated as far as possible from the remaining parts of the interior trim part in order to reduce a risk due to explosive substances. During the assembly, a retaining band, which, according to the generic type, runs between the opening section of the support and the airbag module, has to be fastened securely to said airbag module in a suitable manner in order to be able to reliably absorb the high tensile forces when the airbag is actuated. With the present invention, this fastening takes place without additional measures in the same working step in which the airbag module is attached to the support of the interior trim part.

In an advantageous development of the present invention, it can be provided that the attachment of the intercepting band is placed as exactly as possible on the hinge line of the opening section, and the intercepting band runs from there approximately tautly through the firing passage as far as the other connecting point. This results in an only slightly flexible support of the opening section on the designated hinge line. The latter cannot then curve upward under the force of the expanding airbag into a curved shape with the consequence of breaking or tearing. An undesirable tearing off of the opening section at the hinge line during the deployment of the airbag could otherwise result in undefined dynamics of the separated part and could cause an unforeseeable risk of injury.

In another advantageous development of the present invention, it can be provided that the first section of the retaining band is injected into a separate plastic panel in a first step. The plastic panel is subsequently welded in the region of the opening section of the support. This gives rise to advantages during production. The plastic panel with the retaining band injected into it and the support can initially be produced separately.

An advantageous development of the present invention makes provision for the opening section to be defined in a manner known per se by means of a closed tear line. As a result, when the airbag is actuated, the entire opening section is entirely blasted off. In this case, it has furthermore proven advantageous if the blasted-off cover is then retained by means of a retaining band fastened to the rear side of the opening region and the firing passage.

In this configuration, it is recommended, rather than guiding the retaining band nontautly from the opening section through the firing passage as far as the connecting point to the airbag module, to configure it in a flexible manner by means of an expansion fold in the form of a loop. The loop is preferably designed to be 10-20 mm in length.

Even more far-reaching and advantageous configurations of the present invention are indicated in the subclaims.

### BRIEF DESCRIPTION OF THE DRAWINGS

A preferred embodiment of the present invention is described by way of example below, with reference being made to the attached drawings, in which:

FIG. 1 shows a schematic vertical sectional view through a first interior trim part with an airbag device;

FIG. 2 shows a perspective partial sectional view through those parts of the first interior trim part according to FIG. 1 that are located below the support; and

FIG. 3 shows a schematic vertical partial sectional view through a second interior trim part in the region of the opening section with a panel welded thereon.

### DETAILED DESCRIPTION OF THE PREFERRED EMBODIMENTS

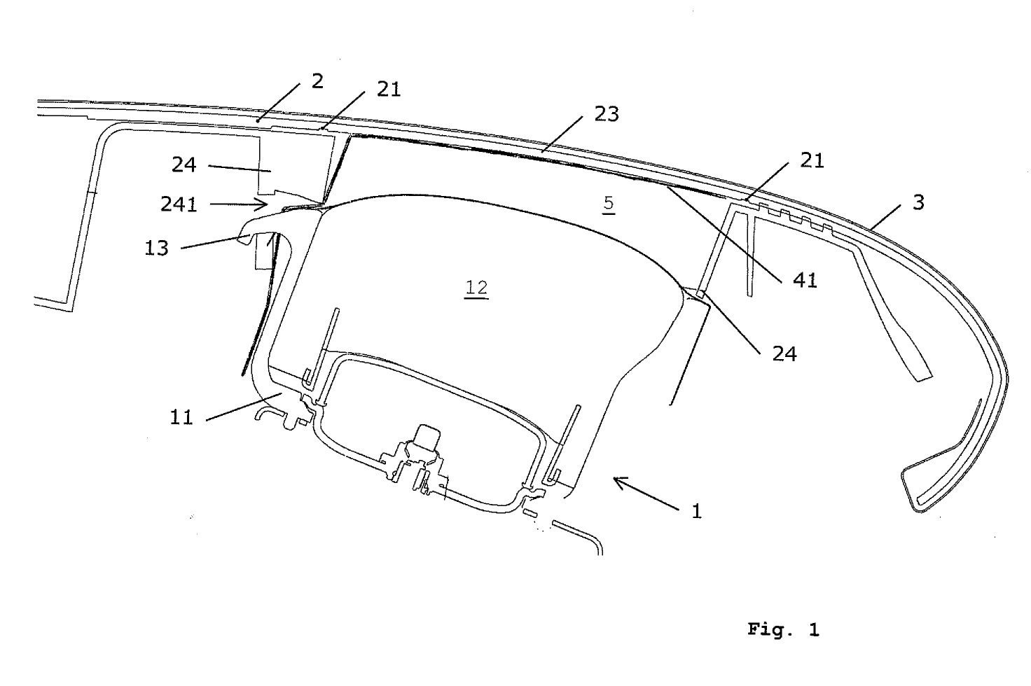

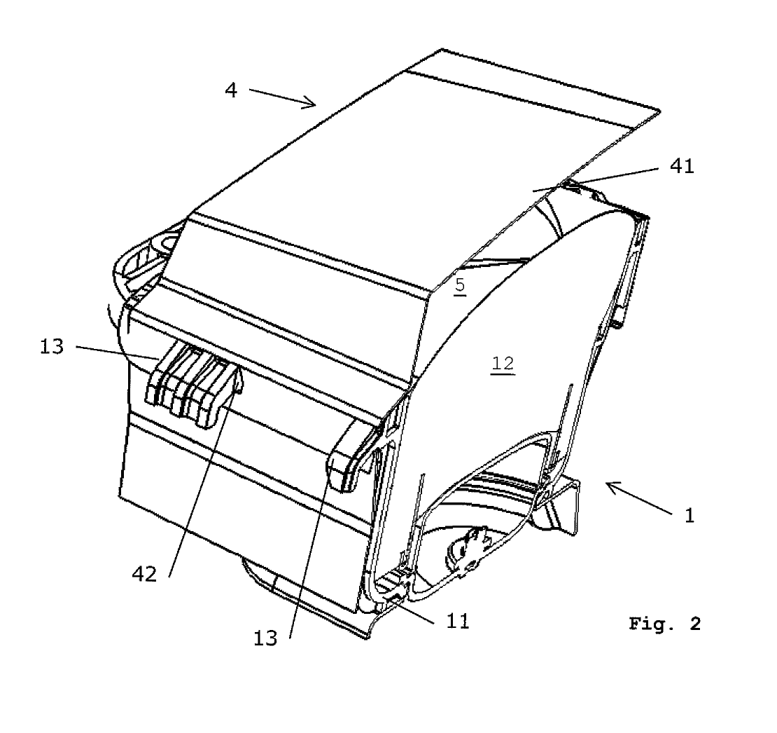

According to FIGS. 1 and 2, a first preferred embodiment of an interior trim part according to the invention with an airbag device comprises a rigid support 2 which is preferably produced from a thermoplastic material by injection moulding. After the installation of the interior trim part, the upper side of the support 2, which side in the present case is virtually planar, faces the passenger compartment and is provided in order to support a decorative layer 3 or to be decoratively designed in some other way. If an additional decorative layer is provided, it may be a leather layer or plastic skin laminated onto the support 2. A decorative configuration of the surface of the support 2 may be brought about by graining. An airbag module 1 as part of a passenger protection device is arranged in a manner known per se below the support 2. The airbag module 1 comprises a pot- or cup-shaped housing 11 in which a folded airbag 12 is accommodated. A gas generator for the deployment of the airbag 12 is typically also provided within the housing 11 of the airbag module 1. In order to protect the airbag 12, the opening of the housing 11 is closed by a protective film or the like.

An opening section 23 on the support 2 permits the airbag 12 to emerge, upon deployment thereof, into the region of the passenger compartment. In the present case, the opening section 23 is defined in a manner known per se by means of a structural or material weakening of the support 2 along continuous tear lines 21 and hinge lines. In the preferred embodiment described in the present case, a structural weakening which is approximately linear in some sections is provided along the encircling tear line 21 and, at said structural weakening, a foreseeable, complete tearing of the material of the support 2 under the action of a predetermined force is possible. In the simplest case, a score with low residual wall thickness or a line perforation is introduced into the material of the support 2 along the tear line 21. A functionally alternative material weakening to the structural weakening described can be achieved, for example, by means of a thermal or chemical embrittlement of the material of the support 2.

If, in an alternative configuration, a hinge line is provided, the latter can be designed as a region of the support 2 that is likewise particularly configured in an approximately linear manner and permits or facilitates a bending-away or hinging of the opening section without the complete separation thereof. For example, a hinge line could be formed as a rectilinear score with sufficient residual wall thickness.

A firing passage 24 is arranged on the support 2 below the opening section 23. The firing passage 24 firstly delimits the deployment space 5 of the airbag 12 to the sides and, as a result, directs the action of the deploying airbag 12 at the opening section 23. Furthermore, the firing passage 24 serves as a flange or mouth for attaching the airbag module 1 to the support 2. The firing passage 24 can be manufactured integrally with the support 2 or can be produced separately therefrom and permanently fastened to the support 2 subsequently. The embodiment described provides a separately produced firing passage 24 which, by means of a suitably selected pairing of material, is welded permanently to the support 2.

The connection of the airbag module 1 to the firing passage 24 can be brought about in a simple manner by means of laterally protruding projections 13 or hook-shaped latching lugs on the housing 11 of the airbag module 1, which projections or latching lugs engage in corresponding cutouts or apertures on the firing passage 24. The airbag module 1 is held at the transverse edges or on the edge lying opposite the latching connection in a conventional manner by means of screw connections. As an alternative to the screw connection, a snap-in connection which can be fitted without tools can also be provided by means of resilient latching hooks or the like.

A retaining band 4 is provided in order to restrain the opening section 23, which is separated entirely or partially from the support 2, in relation to the pulse due to the deploying airbag 12. For this purpose, a first section 41 of the retaining band 4 is preferably connected in a sheet-like manner to the opening section 23.

If, in an alternative embodiment, a hinge line is provided, and the opening section is not intended to be completely separated from the rest of the support, it is particularly advantageous to form said connection between the opening section and the retaining band as close as possible to the hinge line and to align it approximately parallel thereto. In addition, in this configuration, the retaining band runs preferably tautly from the opening section through the firing passage as far as the connecting point to the airbag module.

In the embodiment shown, the retaining band 4 can either run tautly or with an excess length from the opening section 23 through the firing passage as far as the connecting point to the airbag module. A person skilled in the art will make the selection between these two possibilities as a function of the characteristics of the present individual situation. If a flexible configuration of the retaining band 4 is intended to be provided, an expansion fold in the form of a loop which preferably takes up 10-15 mm can be provided for this purpose.

The retaining band 4 is suitably fastened to the connecting point to the airbag module 1 in order to form a counterbearing for the tensile forces which occur. As in the embodiment shown, this fastening is particularly advantageously brought about by apertures or recesses 241 which correspond to the projections 13 on the housing 11 of the airbag module 1 being placed in the retaining band 4. As a result, the retaining band 4 can be reached through, as illustrated, by the latching connection between the firing passage 24 and the airbag module 1.

When the occupant protection device is triggered, the airbag is inflated by the gas from the gas generator and is pushed out of the housing 11 into the firing passage 24. As soon as the airbag completely fills the deployment space 5, the gas pressure acts uniformly on the opening section 23 of the support 2.

When the airbag is actuated, the retaining band 4 becomes taut and subsequently supports the opening section in the region of the rear tear line against the gas pressure. As soon as the force introduced to the opening section by the airbag exceeds a predetermined extent, the opening section 23 partially or completely tears or breaks out of the support 2 in a flap-like manner.

If, in an alternative configuration, a hinge line is provided along a part of the contour line of the opening section, said hinge line can be arranged at a distance from the border edge mentioned. As a result, when the opening section pivots up, that part of the support which is adjacent to the hinge line is pressed down. However, this effect is unproblematic and does not result in any damage to the opening section, the hinge line or the support if the distance between the border edge and hinge line is small. The effect described above is not present if the border edge exactly coincides with the hinge line.

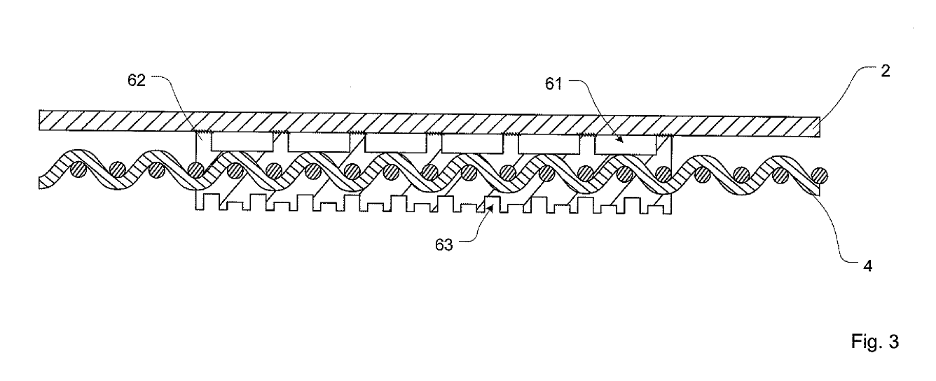

FIG. 3 shows, in a partial section, a partial sectional view through a second preferred embodiment of an interior trim part according to the present invention. Said embodiment differs from the first preferred embodiment described above with reference to FIGS. 1 and 2 in so far as the retaining band 4 according to FIG. 3 is injected into a separate plastic panel 6. As in the exemplary embodiment illustrated, said plastic panel 6 advantageously has a structure with honeycomb-shaped depressions 61 on both sides. Correspondingly web-shaped projections 62 remain between said depressions 61. The depressions may also be of rectangular design. Holes 63 or other depressions are placed on the rear side of the plastic panel 6 to save on material and because of the manufacturing process. The tool parts which protrude into said holes or depressions 63 keep the fabric band in the desired plane in the tool. The plastic panel 6 with the retaining band 4 injected into it is welded in the region of the opening section 23 of the support 2 to the lower side thereof along the web-shaped projections 62. By means of the multi-part design, the support 2 can be produced in a conventional manner without adhesive bonding being necessary as a result. As a rule, the welded connection constitutes lower outlay in terms of manufacturing technology because the firing passage 24 is likewise connected to the support 2 by welding. Accordingly, an additional outlay arises only because of an additional connection of this type. In this regard, an adhesive bond would constitute an entirely strange connecting technique.

### REFERENCE NUMBERS

1 Airbag module
11 Housing
12 Airbag
13 Projections
2 Support
21 Tear line
23 Opening section
24 Firing passage
241 Recesses
3 Decoration
4 Retaining band
41 First section
411 Border edge
42 Apertures
5 Deployment region
6 Plastic panel
61 Depressions
62 Web-shaped projections
63 Holes or cutouts

What is claimed is:

1. Interior trim part with an airbag device, having an airbag module (1) with a pot-shaped housing (11) for accommodating an airbag (12) and a dimensionally stable support (2) with an opening section (23) defined by material or structural weakenings applied along tear lines (21) and with a firing passage (24) which protrudes on one side from said support and is intended for aligning the deployment of the airbag (12) with the opening section (23), wherein the airbag module (1) is arranged at the protruding end of the firing passage (24), characterized in that a first section (41) of a retaining band (4) is attached to the opening section (23), said retaining band running from there within the firing passage (24) as far as the base of the airbag module (1) and being fastened there.

2. Interior trim part with an airbag device according to claim 1, wherein the retaining band (4) is guided out of the deployment region (5) of the airbag through a gap between the airbag module (1) and firing passage (24) and is fastened there.

3. Interior trim part with an airbag device according to claim 2, wherein the retaining band (4) has apertures (42) for the form-fitting hanging on projections (13) on the firing passage (24) or on the airbag module (1).

4. Interior trim part with an airbag device according to claim 3, wherein the projections (13) also bring about between the airbag module (1) and firing passage (24) a latching connection which reaches through the apertures (42) in the retaining band (4).

5. Interior trim part with an airbag device according to claim 4, wherein the first section of the retaining band (41) is injected into a separate panel, in particular a plastic panel (6), and the panel (6) is welded to the support (2) in the region of the opening section (23).

6. Interior trim part with an airbag device, having an airbag module (1) with a pot-shaped housing (11) for accommodating an airbag (12) and a dimensionally stable support (2) with an opening section (23) defined by tear lines (21) and hinge lines and with a firing passage (24) which protrudes on one side from said support and is intended for aligning the deployment of the airbag (12) with the opening section (23), wherein the airbag module (1) is arranged at the protruding end of the firing passage (24), characterized in that a first section (41) of a retaining band (4) is attached to the opening section (23), said retaining band running within the firing passage (24) as far as the base of the airbag module (1) and being fastened there, and the attachment of the retaining band (4) to the opening section (23) being placed in the vicinity of and/or in alignment with the hinge line in order to relieve the hinge line from loading by the opening forces during the deployment of the airbag (12).

7. Interior trim part with an airbag device according to claim 6, wherein the retaining band (4) runs approximately tautly through the firing passage (24).

8. Interior trim part with an airbag device according to claim 7, wherein the attachment of the retaining band (4) to the opening section (23) is a sheetlike connection which is placed along a substantial section of the hinge line.

9. Interior trim part with an airbag device according to claim 8, wherein the first section of the retaining band (41) is injected into a separate panel, in particular a plastic panel (6), and the panel (6) is welded to the support (2) in the region of the opening section (23).

10. Interior trim part with an airbag device according to claim 8, wherein the first section (41) of the retaining band (4) is adhesively bonded to the opening section of the support (2).

11. Interior trim part with an airbag device according to claim 8, wherein the support (2) is composed of thermoplastic material, and the embedding of the first section (41) of the retaining band (4) is obtainable by encapsulation by injection moulding, encapsulation by foaming, backmoulding by injection moulding or compression backmoulding.
